(19) United States
(12) Patent Application Publication
(10) Pub. No.: US 2006/0274103 A1
(43) Pub. Date: Dec. 7, 2006

(54) Apparatus to sense a temperature of a printhead of an inkjet printer and method thereof

(76) Inventor: Jung-hwan Kim, Seoul (KR)

Correspondence Address: STANZIONE & KIM, LLP, 919 18TH STREET, N.W., SUITE 440, WASHINGTON, DC, 20006, US

(21) Appl. No.: 11/437,820

(22) Filed: May 22, 2006

(30) Foreign Application Priority Data
Jun. 1, 2005 (KR) 10-2005-0046786

(51) Int. Cl. B41J 29/38

(52) U.S. Cl. 347/17

(57) ABSTRACT

A method and apparatus to sense a temperature of a printhead of an inkjet printer includes one or more temperature sensors each included in a respective one of the one or more printheads to measure a temperature of each printhead and output an analog signal corresponding to the measured temperature of the one or more printheads, analog buffers each included in the one or more printheads and connected to the temperature sensor of each printhead to control the output of the analog signals according to predetermined control signals, an analog-to-digital converter to digitalize the analog signals output through the analog buffers, and a driving unit connected to the analog buffers to drive the temperature sensors, wherein the analog buffers determine which temperature sensor is driven by the driving unit based on the predetermined control signals.

### CROSS-REFERENCE TO RELATED APPLICATIONS

This application claims the benefit of Korean Patent Application No. 10-2005-0046786, filed on Jun. 1, 2005, in the Korean Intellectual Property Office, the entire disclosure of which is incorporated herein by reference.

### BACKGROUND OF THE INVENTIONGENERAL INVENTIVE CONCEPT

1. Field of the Invention

The present general inventive concept relates to a method and apparatus to sense a temperature of a printhead of an inkjet printer, and more particularly, to a method and apparatus to sense a temperature of a printhead of an inkjet printer including one or more printheads.

2. Description of the Related Art

Printing quality of an inkjet printer depends on a temperature of areas near a printhead of the inkjet printer, that is, the temperature of a head nozzle driving substrate. Thus, in order to ensure good printing quality, the temperature of the printhead needs to be monitored.

FIG. 1 is a view illustrating a conventional single printhead chip 10. The conventional single printhead or printhead chip 10 includes a plurality of nozzles (not shown) used to print a letter or an image by ejecting ink onto a piece of paper, and a temperature sensor 12. The temperature sensor 12 is formed using a diode or a resistor placed on a printhead substrate and operates by sensing a temperature of the printhead substrate of the single printhead chip 10.

FIG. 2 is a schematic view of a conventional temperature sensor using a single printhead chip 20. Referring to FIG. 2, the conventional temperature sensor includes the single printhead chip 20 having a temperature sensor 22, a driving unit 24, and an Analog-to-Digital converter (ADC) 26.

The driving unit 24 includes a resistance R. A voltage corresponding to a sensed temperature and applied to both ends of the temperature sensor 22 is divided by the resistance R, and the result of the division is input to the ADC 26. The ADC 26 digitalizes the analog division result and outputs a digital signal to a control unit (not shown).

FIG. 3 is a schematic view of a conventional temperature sensor using a plurality of single printhead chips of the type illustrated in FIG. 1. Referring to FIG. 3, the conventional temperature sensor includes single printhead chips 30 and 40, driving units 34 and 44, an analog multiplexer 50, and an ADC 60. Although FIG. 3 illustrates two single printhead chips 30 and 40, a wide printhead can be formed using more than two single printhead chips. The wide printhead can print an area corresponding to a full width of a piece of paper during one or more operating runs.

The single printhead chips 30 and 40 together constitute the wide printhead having temperature sensors 32 and 42 to sense the temperatures of the respective single printhead chips 30 and 40, and driving units 34 and 44 to drive the respective temperature sensors 32 and 42. The temperature sensors 32 and 42 of the printhead chips 30 and 40 output analog temperature signals which are input to the analog multiplexer 50. The analog multiplexer 50 selects one of the analog temperature output signals and outputs the selected analog temperature output signal to an Analog-to-Digital converter (ADC) 60. The ADC 60 digitalizes the selected analog temperature output signal output by the analog multiplexer 50 to output an obtained digital signal as a printer system variable. The temperatures of the printhead chips 30 and 40 can be individually selected and read according to the selection of the analog multiplexer 50.

The driving units 34 and 44 for driving the respective temperature sensors 32 and 42 of the single printhead chips 30 and 40 of the wide printhead are provided separately, as illustrated in the conventional temperature sensor of FIG. 3. Output signals of the temperature sensors 32 and 42 driven by the respective driving units 34 and 44 are input to the analog multiplexer 50.

The temperature sensors 32 and 42 are connected to the respective driving units 34 and 44 having the same structure. However, to drive the temperature sensors 32 and 42, both the driving units 34 and 44 corresponding to the respective temperature sensors 32 and 42 are required.

Since certain characteristics of corresponding parts of the driving units 34 and 44 of the respective temperature sensors 32 and 42 may differ from each other, many errors could occur when temperature sensing and conversion operations are performed with the temperature sensors 32 and 42. Also, the output signals of the temperature sensors 32 and 42 must be sent to input terminals of the analog multiplexer 50. Accordingly, there are drawbacks in that the signal lines extending from the outputs of the temperature sensors 32 and 42 to inputs of the multiplexer 50 have to be long.

International Publication No. WO 99/62716 discloses a printhead thermal compensation apparatus and method. However, the publication does not disclose an apparatus and method for sensing the temperature of a printhead for an inkjet printer.

### SUMMARY OF THE INVENTION

The present general inventive concept provides an apparatus to sense the temperature of one or more printheads of an inkjet printer using a common driving unit, and controlling output signals of a temperature sensor in an analog buffer to reduce the number of signal lines.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by a printhead temperature sensor apparatus of an inkjet printer including one or more printheads, the printhead temperature sensor apparatus including one or more temperature sensors each included in a respective one of the one or more printheads to measure a temperature of each printhead and output an analog signal corresponding to the measured temperature of each printhead, analog buffers each included in the one or more printheads and connected to the temperature sensor of each printhead to control the output of the analog signals according to predetermined control signals, an analog-to-digital converter digitalizing the analog signals output through the analog buffers, and a driving unit connected to the analog buffers to drive the temperature sensors, wherein the analog buffers determine which temperature sensor is driven by the driving unit based on the predetermined control signals.

The foregoing and/or other aspects of the present general inventive concept may also be achieved by a method of sensing a temperature of a printhead of an inkjet printer having one or more printheads each including a temperature sensor and an analog buffer included in each printhead and connected to each temperature sensor, the method including measuring a temperature of each printhead and outputting analog signals having levels corresponding to the printhead temperatures measured by the temperature sensors of the printheads, determining whether to drive the temperature sensors in accordance with a predetermined control signal, and whether to output the analog signals, and converting the analog signals output through the analog buffer to digital.

The foregoing and/or other aspects of the present general inventive concept may also be achieved by providing an inkjet printer comprising a printhead cartridge unit comprising: a printhead having a temperature sensor to detect a temperature of the printhead, and an analog buffer connected to the temperature sensor to control an output of the detected temperature, and a driving unit to drive the temperature sensor through the analog buffer, a printer system unit having an converter to convert an output of the detected temperature, and a control unit to control the analog buffer to selectively output the output of the detected temperature.

The foregoing and/or other aspects of the present general inventive concept may also be achieved by providing inkjet printer comprising a plurality of printheads, a plurality of temperature sensors to detect temperatures of corresponding ones of the plurality of printheads, a plurality of analog buffers connected to corresponding ones of the temperature sensors to output the detected temperatures, a control unit to selectively control the analog buffers to output one of the detected temperatures, and an converter to convert the selected one of the detected temperatures. The inkjet printer may further comprises a single driving unit to drive the plurality of temperature sensors through respective ones of the analog buffers.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a conventional single printhead chip;

FIG. 2 is a schematic view illustrating a conventional temperature sensor using a single printhead chip;

FIG. 3 is a schematic view illustrating a conventional temperature sensor using a plurality of single printhead chips;

FIG. 4 is a block diagram illustrating an apparatus to sense a temperature of a printhead using a printhead temperature sensor apparatus according to an embodiment of the present general inventive concept;

FIG. 5 is a schematic view illustrating a temperature sensor using a single printhead chip according to an embodiment of the present general inventive concept;

FIG. 6 is a schematic view illustrating the temperature sensor of FIG. 4;

FIG. 7 is a schematic view illustrating a wide printhead including a plurality of single printhead chips according an embodiment of the present general inventive concept; and

FIG. 8 is a flowchart illustrating a method of sensing the printhead temperature according to an embodiment of the present general inventive concept.

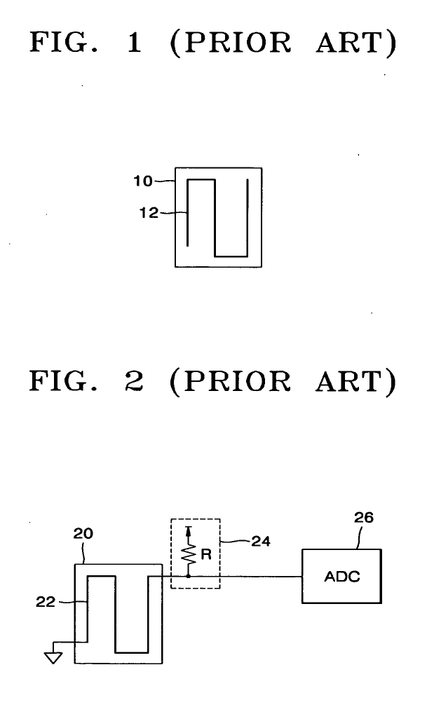

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

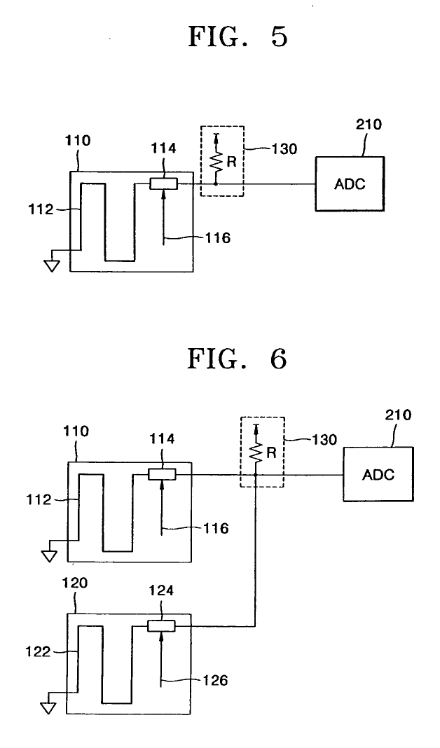

FIG. 4 is a block diagram illustrating an apparatus to sense a temperature of a printhead using a printhead temperature sensor apparatus in an image forming apparatus, for example, an inkjet printer, according to an embodiment of the present general inventive concept. Referring to FIG. 4, the temperature sensor apparatus includes a printhead cartridge unit 100 and a printer system unit 200. The printhead cartridge unit 100 includes one or more printheads 110 and 120, a driving unit 130, and a control unit 140. Each of the printheads 110 and 120 may have a chip form. Therefore, the printheads 110 and 120 are also referred to as single printhead chips. FIG. 5 illustrates a temperature sensor using a single printhead chip according to an embodiment of the general inventive concept.

In FIGS. 4 and 6, only two single printhead chips 110 and 120 are illustrated for clarity. However, it is noted that more than two single printhead chips can be used and included in the printhead cartridge 100. The printer system unit 200 includes an Analog-to-Digital converter (ADC) 210 and a second control unit 220. The printer system unit 200 may include conventional printer elements, of which the description is well-known, and thus detailed description will be omitted.

The single printhead chips 110 and 120 include temperature sensors 112 and 122 and analog buffers 114 and 124, respectively. The analog buffers 114 and 124 receive control signals through enable terminals 116 and 126 thereof, respectively.

The temperature sensors 112 and 122 measure temperatures of the printheads 110 and 120, respectively, and output analog measured signals corresponding to the measured temperatures to the respective analog buffers 114 and 124. The analog buffers 114 and 124 are connected to the temperature sensors 112 and 122, respectively, and can control the output of the analog measured signals output by the temperature sensors 112 and 122 according to predetermined control signals. The predetermined control signals may be output by the control unit 140 of the printhead cartridge unit 100 and input to the analog buffers 114 and 124. The control unit 140 is controlled by the second control unit 220 of the printer system 200. The control unit 140 may be realized with a multiplexer to selectively enable the analog buffers 114 and 124 under the control of the second control unit 220. Alternatively, the control units 140 and/or 220 which enable the analog buffers 114 and 124 can be included in the printer head chips 110 and 120. In this case, the control units 140 and/or 220 may also be realized with multiplexers each of which enables the corresponding analog buffer 114 or 124 under the control of the second control unit 220.

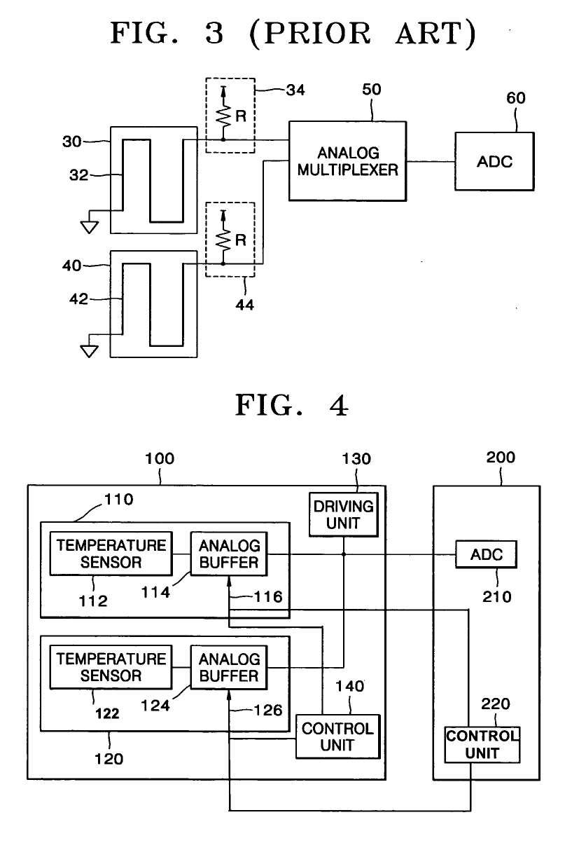

The driving unit 130 is connected to the analog buffers 114 and 124 and drives the temperature sensors 112 and 122 through the analog buffers 114 and 124. The analog buffers 114 and 124 can be used to drive one or more of the temperature sensors 112 and 122 based on predetermined control signals received. In the conventional temperature sensor of FIG. 3, each temperature sensor 32 and 42 includes a respective driving unit 34 and 44. However, by using the analog buffers 114 and 124 including the respective enable terminals 116 and 126, one driving unit 130 can be used to drive both temperature sensors 112 and 122. The analog-to-digital converter (ADC) 210 digitalizes the analog measured signals of the temperature sensors 112 and 122 output by the analog buffers 114 and 124.

Referring to FIG. 6, the driving unit 130 including a resistor R distributes a voltage or power to printheads 110 and 120 so that the driving unit 130 allows the temperature sensors 112 and 122 to output the measured temperature signals. FIG. 6 illustrates the driving unit 130 including only the resistor R, driving the temperature sensors 112 and 122, but other various types of driving circuits can also be used to drive the temperature sensors 112 and 122.

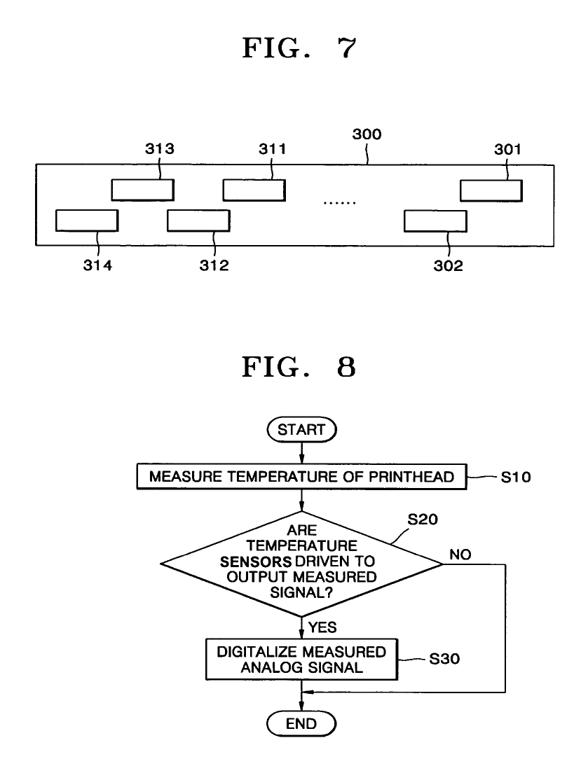

The printheads 110 and 120 can constitute a wide printhead 300, which can print an area corresponding to a full width of a piece of paper during one or more operation runs. FIG. 7 illustrates a wide printhead 300 according to an embodiment of the present general inventive concept. Referring to FIG. 7, a wide printhead 300 may include, for example, fourteen single printhead chips (301 to 314). A conventional print cartridge unit including only a single printhead prints an image by performing a reciprocating motion. However, the wide printhead 300 can print an image without a reciprocating motion, and thus it has a higher printing speed.

Referring to FIG. 7, the wide printhead 300 is generally formed of a plurality of single printhead chips 301, 302, 303, 304, 305, 306, 307, 308, 309, 310, 311, 312, 313, and 314. Each of the single printhead chips 301 to 314 resembles a shuttle-type printhead. That is, each chip may include nozzles and heaters to eject ink, an interface circuit unit (not shown) to communicate with the control unit 220 of the printer system 200, and the temperature sensors 112 and 122 to read the substrate temperature of each chip. The temperature sensors 112 and 122 provided on the printhead chips 110 and 120 sense the temperature of ejected ink in order to obtain a high quality print output. If the sensed temperature is lower than an optimal driving temperature, which may be represented by a predetermined threshold, the substrate is heated, and if the sensed temperature is higher than the optimal temperature, the single printhead chip waits until the temperature of ink to be ejected decreases before operating the printhead.

As described above, in the conventional temperature sensor of FIG. 3, the driving circuits 34 and 44 are separately provided to drive the temperature sensors 32 and 42 to sense the temperatures of the respective printhead chips 30 and 40. Also, the analog multiplexer 50 of FIG. 3 must selectively provide output signals of each temperature sensor 32 or 42 to the ADC 60 of FIG. 3.

In the present embodiment of FIG. 4, the analog buffers 114 and 124 include the enable terminals 116 and 126 on each of the single printhead chips 110 and 120, respectively. As the analog buffers 114 and 124 are provided in the single printhead chips 110 and 120, respectively, the number of signal lines can be reduced compared with the conventional configuration of FIG. 3 where the analog multiplexer 50 requires a signal line corresponding to each printhead chip. In other words, as illustrated in FIG. 4, it is possible that only one signal line is used to connect the print cartridge 100 with the ADC 210 of the printer system unit 200.

The control unit 140 may provide the control signals input through the enable terminals 116 and 126 of the respective analog buffers 114 and 124. Thus, by using the signal lines, the control signals controlling the analog output signals 9analog temperature signals) of the temperature sensors 112 and 122 can be received from the control unit 220 without using additional signal lines.

The analog buffers 114 and 124 can be enabled or disabled to output the analog output signals based on the predetermined control signals. When the outputs of the analog buffers 114 and 124 are enabled by the control signals, the driving unit 130 may be disposed outside the printheads 110 and 120 and connected to the temperature sensors 112 and 122 to drive the temperature sensors 112 and 122 to output the analog output signal. At this point, only one of the analog buffers 114 and 124 is enabled at a time. Thus, only the enabled one of the analog buffers 114 and 124 may be used to drive a corresponding one of the temperature sensors 112 and 122. Once the analog output signals corresponding to the temperatures of the printheads 110 and 120 have been measured by the temperature sensors 112 and 122, the analog output signals can be transmitted to the ADC 210.

FIG. 8 is a flowchart illustrating a method of sensing the temperatures of the printheads 110 and 120 according to an embodiment of the present general inventive concept. Referring to FIG. 8, the temperatures of the printheads 110 and 120 are measured, respectively, and analog signals corresponding to the measured temperatures are output, at operation S10.

The temperature sensors 112 and 122 are driven by the driving unit 130 and the corresponding analog output signals are controlled in accordance with predetermined control signals input to the analog buffers 114 and 124 which are included in the printheads 110 and 120, and connected to the temperature sensors 112 and 122 of the printheads 110 and 120, at operation S20. The analog measured signals of the temperature sensors 112 and 122 output by the analog buffers 114 and 124 are digitalized, at operation S30.

The control unit 140 of the cartridge unit 100 outputs the control signals and inputs them to the analog buffers 114 and 124 through the respective enable terminals 116 and 126. The printheads 110 and 120 may have a chip form.

The printheads 110 and 120 together can constitute a wide printhead which can print an area corresponding to a full width of a piece of paper in one or more operation runs. FIG. 7 illustrates an embodiment of a wide printhead.

As described above, according to the present general inventive concept, circuit design of a temperature sensor driving unit is simplified by using only one temperature sensor driving unit to drive a temperature sensor of the plurality of single printheads. Also, the number of output signal lines can be reduced. The output signals of the temperature sensors can be transmitted to an ADC without using an analog multiplexer.

In addition, by simplified designing of temperature sensor driving circuits, the number of temperature sensor driving circuits to drive and read temperature sensors may be reduced to one. Also, one temperature sensor driving circuit may drive more than one temperature sensor. Therefore, the temperature errors can be reduced, which may occur due to variations of characteristics of temperature sensor driving circuit parts when a plurality of temperature sensor driving circuits are used.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printhead temperature sensor apparatus of an inkjet printer including one or more printheads, the printhead temperature sensor comprising:
one or more temperature sensors each included in a respective one of the one or more printheads to measure a temperature of each printhead and output an analog signal corresponding to the measured temperature of each printhead;
analog buffers each included in the respective one of the one or more printheads and connected to the temperature sensor of each printhead to control the analog signals according to predetermined control signals;
an analog-to-digital converter to digitalize the analog signals output through the analog buffers; and
a driving unit connected to the analog buffers to drive the temperature sensors,
wherein the analog buffers determine which temperature sensor is driven by the driving unit based on the predetermined control signals.

2. The printhead temperature sensor apparatus of claim 1, wherein the predetermined control signals are output by a control unit of a printhead cartridge unit including the one or more printheads and the driving unit.

3. The printhead temperature sensor apparatus of claim 2, wherein the one or more printheads and the driving unit constitute the printhead cartridge unit, and the control unit selectively enables the analog buffer under the control of a controller of a printer system unit connected to the printhead cartridge unit.

4. The printhead temperature sensor apparatus of claim 1, wherein each of the one or more printheads has a chip form.

5. The printhead temperature sensor apparatus of claim 1, wherein the one or more printheads constitute a wide printhead which can print an area corresponding to a full width of a piece of paper in one or more operation runs.

6. The printhead temperature sensor apparatus of claim 1, wherein the driving unit is used to drive the one or more temperature sensors.

7. A method of sensing a temperature of a printhead of an inkjet printer having one or more printheads each including a temperature sensor and an analog buffer included in each printhead and connected to each temperature sensor, the method comprising:
measuring a printhead temperature of each printhead and outputting analog signals having levels corresponding to the printhead temperatures measured by the temperature sensors of the printheads;
determining whether to drive the temperature sensors according to predetermined control signals, and whether to output the analog signals; and
converting the analog signals output through the analog buffer to a digital signal.

8. The method of sensing the printhead temperature of claim 7, wherein the predetermined control signals are output by a control unit of a printhead cartridge including the one or more printheads.

9. The method of sensing the printhead temperature of claim 8, wherein the control signals are output by the control unit of the printhead cartridge under the control of a controller of a printer system connected to the printhead cartridge.

10. The method of sensing the printhead temperature of claim 7, wherein each of the one or more printheads has a chip form.

11. The method of sensing the printhead temperature of claim 7, wherein the one or more printheads constitute a wide printhead which can print an area corresponding to a full width of a piece of paper in one or more operation runs.

12. An inkjet printer comprising:
a printhead cartridge unit comprising:
a printhead having a temperature sensor to detect a temperature of the printhead, and an analog buffer connected to the temperature sensor to control an output of the detected temperature, and
a driving unit to drive the temperature sensor through the analog buffer;
a printer system unit having a converter to convert an output of the detected temperature; and
a control unit to control the analog buffer to selectively output the output of the detected temperature.

13. The inkjet printer of claim 12, wherein:
the printhead cartridge further comprising a second printhead having a second temperature sensor to detect a second temperature of the printhead, and a second analog buffer connected to the temperature sensor to control a second output of the detected second temperature;
the driving unit drives the second temperature sensor through the second analog buffer; and
the control unit controls the second analog buffer to selectively output the second output of the detected second temperature.

14. The inkjet printer of claim 13, wherein the converter converts one of the output of the detected temperature and the second output of the detected second temperature.

15. The inkjet printer of claim 13, wherein the control unit generates a signal to select one of the analog buffer and the second analog buffer such that one of the detected temperature and the detected second temperature.

16. The inkjet printer of claim 13, wherein the control unit is disposed one of the printhead cartridge and the printer system unit.

17. The inkjet printer of claim 13, wherein the printer system unit performs a printing operation using the printhead and the second printhead according to the converted one of the detected temperature and the detected second temperature.

18. The inkjet printer of claim 13, wherein the printhead comprises a plurality of printheads each having the temperature sensor to detect the temperature of the printhead, and the analog buffer connected to the temperature sensor to control an output of the detected temperatures, and the control unit controls the analog buffers to transmit one of the detected temperatures.

19. An inkjet printer comprising:
a plurality of printheads;
a plurality of temperature sensors to detect temperatures of corresponding ones of the plurality of printheads;
a plurality of analog buffers connected to corresponding ones of the temperature sensors to output the detected temperatures;
a control unit to selectively control the analog buffers to output one of the detected temperatures; and
a converter to convert the selected one of the detected temperatures.

20. The inkjet printer of claim 13, further comprising:
a single driving unit to drive the plurality of temperature sensors through respective ones of the analog buffers.
